(19) United States
(12) Patent Application Publication
(10) Pub. No.: US 2012/0286218 A1
(43) Pub. Date: Nov. 15, 2012

(54) LOW COST ALTERNATIVES TO CONDUCTIVE SILVER-BASED INKS

(75) Inventors: Zequn Mei, Fremont, CA (US); Darren Lochun, Mountain View, CA (US)

(73) Assignee: NANOSOLAR, INC., San Jose, CA (US)

(21) Appl. No.: 13/469,893

(22) Filed: May 11, 2012

Related U.S. Application Data
(60) Provisional application No. 61/485,072, filed on May 11, 2011.

(51) Int. Cl. H01B 1/02; H01B 1/22

(52) U.S. Cl. 252/512

(57) ABSTRACT

A method of making an electrically conductive ink is provided. This ink is suitable for use in a photovoltaic device. The method includes the steps of providing solder particles, providing a surface oxide removal material; and formulating an ink with the solder particles and the surface oxide removal material. As a result, a solder is formed. This solder maintains electrical conductivity when used in the ink at a processing temperature less than 250 C.

### CROSS-REFERENCES TO RELATED APPLICATIONS

This application claims priority to U.S. Provisional Application No. 61/485,072 filed on May 11, 2011, and entitled “Low cost alternatives to conductive silver-based inks”, which is hereby incorporated by reference for all purposes.

### FIELD OF THE INVENTION

This invention relates generally to electrically conductive inks, and more specifically, to electrically conductive inks used in printed electronics devices, such as, photovoltaic devices.

### BACKGROUND OF THE INVENTION

The use of precious metals in the manufacturing of electronic devices, optoelectronic devices, and photovoltaic devices such as solar cells has created significant exposure in the material costs to the volatility of the precious metals markets. For example, many solar cells use silver-based epoxy inks to print electrical traces or finger and the recent doubling of silver prices on the spot market has created an unexpected rise in the manufacturing cost of such solar cells.

The difficulty in replacing silver is that a direct replacement by lower cost materials typically results in a product with significantly poorer performance. For example, replacing silver flakes in the solar cell epoxy ink with solder powder particles does not result in a viable replacement. The electrical resistance in the resulting ink is high due to the electrically resistive surface oxide of the solder powder particles. Although conductive solder inks can be made and are sold, they require the use of a secondary flux material at the point of application. This can easily damage solar cells, and it is difficult to remove.

There remains substantial improvement that can be made to component photovoltaic cells and photovoltaic modules that provide for reduced cost without reduced performance.

### SUMMARY OF THE INVENTION

Embodiments of the present invention address at least some of the drawbacks set forth above. It should be understood that at least some embodiments of the present invention may be applicable use with various types of photovoltaic absorber materials. At least some of these and other objectives described herein will be met by various embodiments of the present invention.

A method of making an electrically conductive ink is provided. This ink is suitable for use in a photovoltaic device. The method includes the steps of providing solder particles, providing a surface oxide removal material; and formulating an ink with the solder particles and the surface oxide removal material. As a result, a solder is formed. This solder maintains electrical conductivity when used in the ink at a processing temperature less than 250 C.

A further understanding of the nature and advantages of the invention will become apparent by reference to the remaining portions of the specification and drawings.

### BRIEF DESCRIPTION OF THE DRAWINGS

The teachings of the present invention can be readily understood by considering the following detailed description in conjunction with the accompanying drawings, in which:

FIG. 1 shows an embodiment of the present invention.

FIG. 2 illustrates a configuration with core-shell solder particles with an outer shell of noble metal and a core of solder material.

### DETAILED DESCRIPTION OF THE EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

In one embodiment of the present invention, the silver in the ink can be replaced by alternative particles by using an activation additive and a processing step to active the additive. By way of non-limiting example, the constituent parts of the ink includes but is not limited to solder power particles with resin and/or rosin powders are added as a secondary and/or tertiary ingredients. A solvent may be included. The sequence of mixing can be all together at the same time, with or without solvent, and with or without heating. Optionally, the rosin and solder are mixed together first, with or without solvent, and with or without heating. Optionally, solder and resin are mixed together first, with or without solvent, and with or without heating. Optionally, rosin and resin are mixed together first, with or without solvent, and with or without heating. When the ink is cured at a pre-determined temperature or higher, the resin and/or rosin activates and fluxes the solder. The molten solder particles join together and form continuous links.

In one embodiment, the desired temperature is about 175 C or higher. Optionally, the desired temperature is 165 C or higher. The linking of the solder particles in this fashion can create a percolating network that allows for electrical conductivity and minimizes the effect of surface oxides that may have been present when the solder was in particle form without the need for a secondary flux, such as inorganic fluxes (that contain highly corrosive inorganic acids), organic acid fluxes (which are milder and also tend to be water soluble) and rosin based fluxes. Although epoxy is described as the resin system in the examples herein, it should be understood that other resin systems are not excluded. Another embodiment utilizes thermoplastic resin systems.

Modifications to solder particles or the resulting ink are described that allow the solder to maintain electrical conductivity when used in inks, such as epoxy inks, at processing temperatures less than 250 C.

### Use of Surface Oxide Removal Additive

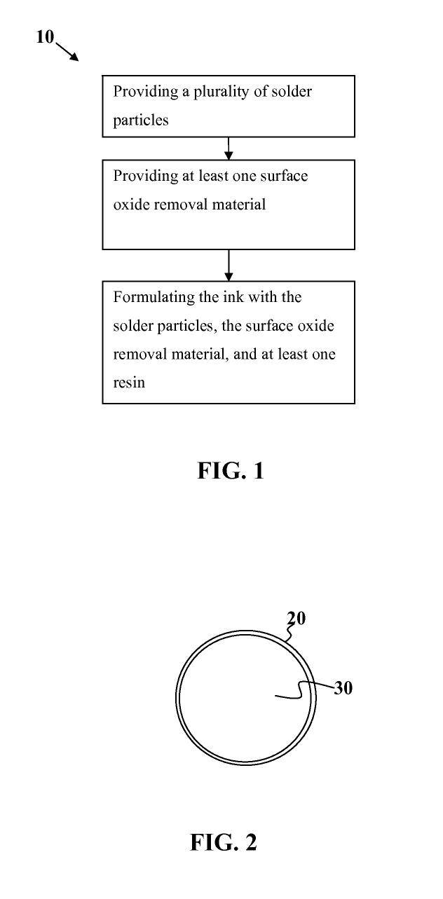

In one embodiment as seen in FIG. 1, it may be desirable to add a surface oxide removal material such as rosin powders into the electrically conductive ink as a second ingredient. Rosin is brittle and friable at ambient temperature. This enables powder to be made from rosin. Rosin is semi-transparent at ambient temperature and chemically inactive. At high temperatures (>120 C), it melts and becomes chemically active, reducing the surface oxide of solder particles. In some embodiments, rosin comprises mainly of abietic acid (70 to 85 percent, depending on the source) with 10 to 15 percent pimaric acids. Rosin fluxes are inactive at room temperatures but become active when heated to soldering temperatures. They are naturally acidic (in one embodiment, 165 to 170 mg KOH per g equivalent).

The rosin used herein may be one or more of the following. Rosin (R) Flux: It has only rosin and is the least active. This type of flux is mostly used for surfaces that arc clean. It leaves virtually no residue after soldering. Rosin Mildly Activated (RMA) Flux: It has sufficient activator to clean the solder-coated or plated lands and component terminations or leads, thereby enabling the molten solder to wet these areas. Rosin Activated (RA) Flux: Type RA is the most active of the rosin fluxes and leaves the most residue after soldering.

In one non-limiting example, silver flakes in the epoxy ink are replaced with Bi—Sn solder such as 58Bi-42Sn solder powders (138 C melting), although other low melting solders are not excluded. The loadings of the solder powder can be 70, 80, 90 loadings weight/weight %. The loadings of the solder powder can be between 70 to 90 weight/weight %. Rosin powder may be added in the percentage of about 5%. Optionally, some embodiments may add rosin at about 10% by weight. Optionally, some embodiments may add rosin at about 15% weight. Optionally, some embodiments may add rosin at about 20% weight. Rosin powder may be added in the percentage of about 5% to 20% by weight. The ratio of rosin to the primary ink or epoxy ingredient may be based on the ranges as set forth above. Optionally, some additive might be added to adjust viscosity of the ink to maintain good printability. In one embodiment, the weight % of rosin is impacted by the weight percent of solder. An inert filler such as silica or alumina in the 0 to 5 weight percent can be included to maintain printability. Optionally, Bi—Sn—Pb or other lead based solders arc not excluded. Optionally, Sn—Zn solder may be used. Solders with melting temperatures as high as 200 C may also be used. Optionally, solders with melting temperatures as high as 250 C may also be used.

Simply replacing silver flakes with solder powder will result in high electric resistance because of the surface oxide on the solder powder.

Rosin is chemically inactive at ambient temperature, but becomes flux for soldering at high temperature because of resin acid. Adding rosin powder as the 2nd ingredient into the mixture of epoxy or ink solder powder can be desirable. When heated above both the flux activation temperature and solder melting point, solder powder particles melts and joins together, forming continuous electrically conductive links. In some embodiments the heating may be up to 125 C. Optionally, some embodiments may heat to up to 150 C. Optionally, some embodiments may heat to up to 200 C. Optionally, some embodiments may heat to up to 225 C. Optionally, some embodiments may heat to up to 250 C.

The rosin flux activation temperature is probably at 110 C or so. One may choose eutectic 58Bi-42Sn with melting temperature of 138 C as solder. Other solders of high temperature, e.g. eutectic Sn—A;, Sn—Ag—Cu, Sn—Cu, are also candidates, if solar panel process can sustain their melting temperatures.

Rosin is brittle and friable at ambient temperature. One can easily make rosin powder or particles. This method may involve adding rosin powder and solder powder into epoxy or ink liquid, and mixing the components together to form the final ink.

Coating Solder Particles with Noble Metal(s)

One alternative method to using bare solder particles is to coat the solder powders or particles with a noble metal, which by way of non-limiting example, may include using immersion plating methods. As seen in FIG. 2, this may result in core-shell solder particles with an outer shell 20 of noble metal and a core 30 of solder material. One or more metals may be used. One or more shells may be formed. By way of non-limiting example, the core may be Bi—Sn solder such as but not limited to 58Bi-42Sn or other solders of high temperature, e.g. eutectic Sn—Ag, Sn—Ag—Cu, Sn—Cu. Some embodiments may also dope the solder with some other material such as but not limited to silver to have embodiments such as Bi—Sn—Ag which may be 57Bi-42Sn-1Ag. Selecting a melting metal (solder) has the advantage of continuous links after the metal powder melts and loins together.

This embodiment may replace Ag flake with Ag coated low cost metal powder. Some may also have Ag-coated Cu disc or epoxy.

Although other techniques are not excluded, immersion plating of either Ag, Au, or Pd might be used as coating methods. Unlike electrolytic plating, Immersion plating doesn't require electrodes or power supply. Different from electroless plating, immersion plating does not require catalysis; it is self-catalytic. In theory, in the electromotive force (EMF) series of elements, a more noble element can be plated on the surface of a less noble element. For example, Au, Ag, or Pd ions in solutions may take the electrons from Cu or Sn atoms, then deposit on their surface. The Cu or Sn atom become ions, and dissolve into the solutions. The coating is self-limiting; after the Cu or Sn surface is covered with Au, Ag, or Pd, the reaction stops.

The material chosen may be at least one of Au, Ag, or Pd because commercial chemical solutions of immersion Au, Ag, and Pd are commonly available. However, other suitable materials are not excluded.

A simple coating process might be the following:
wrap metal powder (Sn—Bi solder, or Cu) in a cloth.
clip into an acidic solution, to remove the surface oxide of the metal.
dip into water, to rinse off the acid.
dip into immersion plating solution for a few minutes.
clip into water, to rinse off the solution.

The thin coating of noble metals over solder powder surface dissolves into the molten solder, and is alloyed into the solder, e.g. becoming Sn—Bi—Ag, Sn—Bi—Au.

Either of the above embodiments (core-shell solder particles or oxide-removal material/ingredient) may be used alone or in combination with each other.

While the above is a complete description of one or more embodiments of the present invention, it is possible to use various alternatives, modifications and equivalents. For example, those of skill in the art will recognize that any of the embodiments of the present invention can be applied to almost any type of solar cell material and/or architecture. Although the present invention primarily discusses CIGS absorber layer, the foil substrate may be used with absorber layers that include silicon, amorphous silicon, organic oligomers or polymers (for organic solar cells), bi-layers or interpenetrating layers or inorganic and organic materials (for hybrid organic/inorganic solar cells), dye-sensitized titania nanoparticles in a liquid or gel-based electrolyte (for Graetzel cells in which an optically transparent film comprised of titanium dioxide particles a few nanometers in size is coated with a monolayer of charge transfer dye to sensitize the film for light harvesting), copperindium-gallium-selenium (for CIGS solar cells), CdSe, CdTe, Cu(In,Ga)(S,Se)7, Cu(In,Ga,Al)(S,Se,Te)2, Ag—Cu(In,Ga,Al)(S,Se,Te)2, CZTS, IB-IIB-NA-VIA absorbers, and/or combinations of the above, where the active materials are present in any of several forms including but not limited to bulk materials, micro-particles, nano-particles, or quantum dots. The CIGS cells may be formed by vacuum or non-vacuum processes. The processes may be one stage, two stage, or multi-stage CIGS processing techniques. Additionally, other possible absorber layers may be based on amorphous silicon (doped or undoped), a nanostructured layer having an inorganic porous semiconductor template with pores filled by an organic semiconductor material (see e.g., US Patent Application Publication US 20050121068 A1, which is incorporated herein by reference), a polymer/blend cell architecture, organic dyes, and/or C60 molecules, and/or other small molecules, micro-crystalline silicon cell architecture, randomly placed nanorods and/or tetrapods of inorganic materials dispersed in an organic matrix, quantum dot-based cells, or combinations of the above. Many of these types of cells can be fabricated on flexible substrates.

Therefore, the scope of the present invention should be determined not with reference to the above description but should, instead, be determined with reference to the appended claims, along with their full scope of equivalents. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method of making an electrically conductive ink for use in a photovoltaic device, the method comprising the steps of:
providing solder particles;
providing a surface oxide removal material; and
formulating an ink with the solder particles and the surface oxide removal material;
wherein a solder is formed; and
wherein the solder maintains electrical conductivity when used in the ink at a processing temperature less than 250 C.

2. The method of claim 1, wherein the ink includes a resin.
